(19) United States
(12) Patent Application Publication
(10) Pub. No.: US 2015/0325094 A1
(43) Pub. Date: Nov. 12, 2015

(54) PROVIDING RECOMMENDATIONS BASED ON DETECTION AND PREDICTION OF UNDESIRABLE INTERACTIONS

(71) Applicant: International Business Machines Corporation, Armonk, NY (US)

(72) Inventors: Tsz S. Cheng, Grand Prairie, TX (US); Gregory P. Fitzpatrick, Keller, TX (US)

(73) Assignee: International Business Machines Corporation, Armonk, NY (US)

(21) Appl. No.: 14/273,664

(22) Filed: May 9, 2014

(51) Int. Cl. G08B 21/10; G08B 21/18

(52) U.S. Cl. CPC G08B 21/10; G08B 21/182

(57) ABSTRACT

One or more processors retrieve a set of data based on a variable of a rule. The rule is configured to evaluate a subject based on a preference of a user. One or more processors identify an opinion of a second user regarding the subject. One or more processors use the opinion of the second user and the set of data to define a value that corresponds to the variable of the rule. One or more processors determine a course of action to be recommended for the first user. The determination is based on incorporation of the value as the variable of the rule and on the preference of the first user.

### BACKGROUND OF THE INVENTION

The present invention relates generally to the field of safety, and more particularly to providing real-time feedback to users.

With the advent of social media sites and interconnectivity that has resulted from the World Wide Web there has been an exponential increase in the quantity of data that can be accessed online. In certain situations, interactions can be, or may become, undesirable. In some cases, such undesirable interactions may include or lead to social awkwardness, embarrassment, or, in other cases, an inter-personal conflict. In other cases, an undesirable interaction can be something an individual wishes to avoid, such as certain types of food or activities.

For example, an undesirable interaction occurs when two strongly opposing political groups attend the same venue at the same time. In another example, two individuals have had a previous quarrel and, as such, future interactions with one another are deemed an undesirable interaction. In a third example, an individual wishes to change his or her eating habits, and, as such, would prefer to avoid future encounters with certain types of food venues after a certain hour of night. Therefore, attending those food venues is deemed an undesirable interaction.

### SUMMARY

Embodiments of the present invention provide a method, system, and program product to recommend a course of action. One or more processors retrieve a set of data based, at least in part, on a variable of a rule. The rule is configured to evaluate a subject based, at least in part, on a preference of a first user. One or more processors identify an opinion of a second user regarding the subject. One or more processors use the opinion of the second user and at least a part of the set of data to define a value that corresponds to the variable of the rule. One or more processors determine a course of action to be recommended for the first user, the determination being based, at least in part, on incorporation of the value as the variable of the rule and on the preference of the first user.

### BRIEF DESCRIPTION OF THE SEVERAL VIEWS OF THE DRAWINGS

FIG. 1 is a functional block diagram illustrating a dynamic hazard generating environment, in accordance with an exemplary embodiment of the present disclosure.

FIG. 2 is a flowchart illustrating operational processes of a personal safety program, executing on a computing device within the environment of FIG. 1, in accordance with an exemplary embodiment of the present disclosure.

FIG. 3 depicts a block diagram of components of a mobile device and the computing device executing the personal safety program, in accordance with an exemplary embodiment of the present disclosure.

### DETAILED DESCRIPTION

A hazard, as used herein, refers to a state of being (e.g., a situation, an environment, a scenario), which has been determined to pose a potential undesired result for a user, i.e., an undesirable interaction.

Embodiments of the present invention recognize that what is considered to be a hazard varies according to each person. Embodiments of the present invention recognize that, based on the definition of a hazard, various sources of data are required in order to make assessments of potential hazards. Embodiments of the present invention provide a personalized assessment of potential hazards that can assist individuals in the avoidance of those hazards. Embodiments of the present invention recognize that not all users are privy to the same information and, as such, their respective opinions vary accordingly. Embodiments of the present invention provide the inclusion of an opinion of a user as a variable of a rule, which yields an increase in accuracy when assessing a potential hazard using that rule. Certain embodiments of the present invention provide notification to a user of a certain hazard if a threshold related to that hazard has been reached. Embodiments of the present invention recognize that a hazard can come into existence when two or more variables that individually do not constitute a hazard combine. Certain embodiments of the present invention provide a user with an alternative action to mitigate a potential hazard from being realized.

The present invention will now be described in detail with reference to the Figures.

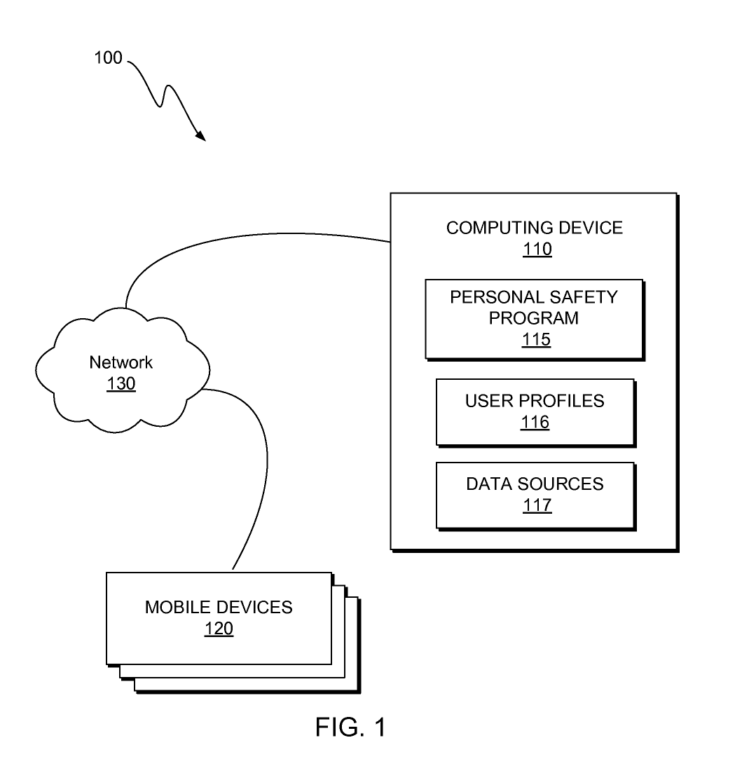

FIG. 1 is a functional block diagram illustrating a dynamic hazard generating environment, generally designated 100, in accordance with one embodiment of the present disclosure. Dynamic hazard generating environment 100 includes server computing device 110 and mobile devices 120 connected over network 130. Server computing device 110 includes personal safety program 115, user profiles 116, and data sources 117.

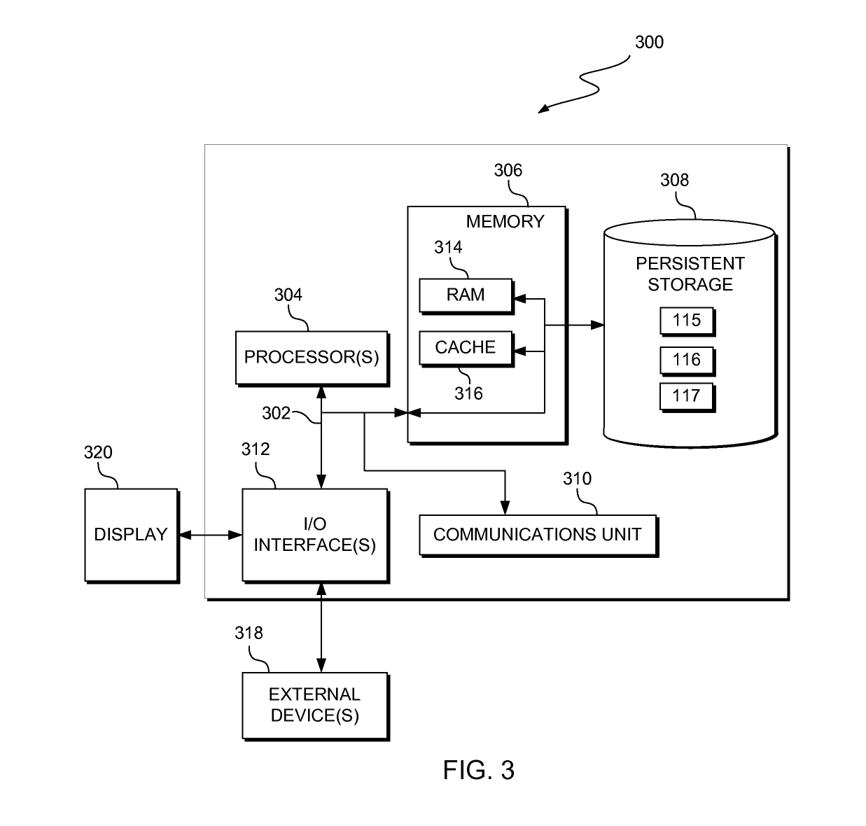

In various embodiments of the present disclosure, server computing device 110 is a computing device that can be a standalone device, a server, a laptop computer, a tablet computer, a netbook computer, a personal computer (PC), or a desktop computer. In another embodiment, server computing device 110 represents a computing system utilizing clustered computers and components to act as a single pool of seamless resources. In general, server computing device 110 can be any computing device or a combination of devices with access to personal safety program 115, user profiles 116, and data sources 117 and is capable of executing personal safety program 115. Server computing device 110 may include internal and external hardware components, as depicted and described in further detail with respect to FIG. 3.

In this exemplary embodiment, personal safety program 115, user profiles 116, and data sources 117 are stored on server computing device 110. However, in other embodiments, personal safety program 115, user profiles 116, and data sources 117 may be stored externally from computing device 110 and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between server computing device 110, mobile devices 120, personal safety program 115, user profiles 116, and data sources 117, in accordance with a desired embodiment of the present disclosure.

In various embodiments of the present disclosure, mobile devices 120 are computing devices that can be smartphones, laptop computers, tablet computers, netbooks computers, personal computers (PCs), or desktop computers that are connected to network 130. In another embodiment, mobile devices 120 represent a computing system utilizing clustered computers and components to act as a single pool of seamless resources. For example, a laptop computer that is connected to an external global positioning system (GPS) locator. In general, mobile devices 120 can be any computing device or a combination of devices capable of determining a location of mobile devices 120 and is capable of communicating that location to personal safety program 115 via network 130. In certain embodiments, mobile devices 120 are configured to update user profiles 116 in response to input from a user. Mobile devices 120 may include internal and external hardware components, as depicted and described in further detail with respect to FIG. 3, in accordance with various embodiments of the present disclosure.

In exemplary embodiments, personal safety program 115 uses a set of customized rules for a given user, which are created by the user and included in user profiles 116, to generate a set of search parameters for a particular subject. Personal safety program 115 searches a variety of data sources and aggregates real-time information. Personal safety program 115 identifies the opinions of other users regarding the subject. Personal safety program 115 applies the set of customized rules, for that given user, to the aggregated real-time information and identified opinions and generates a result. Personal safety program 115 presents the result to the given user to assist the user in avoidance of potential hazards by recommending a course of action for the user. In general, personal safety program 115 includes the capability to provide a customized assessment of potential hazards for an individual based on data mined from data sources that are often unstructured. This assessment is holistic in that it is limited only by the rules that the user creates and are applied by personal safety program 115 to generate that assessment.

In this embodiment, personal safety program 115 has the capability to derive at least three different types of information based on data included in data sources 117. Personal safety program 115 has the capability to derive identifications of individuals based on limited, and sometimes anonymous, internet postings, such as postings on blogs or social media sites that are herein represented as data included in data sources 117. Personal safety program 115 has the capability to derive planned destinations for individuals based on the data included in data sources 117. In addition, personal safety program 115 has the capability to derive individual sentiment based on internet postings, such as postings on blogs or social media sites included in data sources 117.

Since an opinion of a user is often based on the limited information that is available to that user, personal safety program 115 has the capability to take into account the opinions of others users regarding a particular subject. For example, the user has written a rule that dictates that only three star (or better) restaurants are considered safe because the user feels that there is a decreased chance of food poisoning in such establishments. Restaurant A is a four star restaurant. As such, based on only the rule defined by the user, an attempt by the user to attend such a restaurant would not result in personal safety program 115 generating a message indicating a warning of potential food borne illness. However, because personal safety program 115 takes into account the opinions, i.e., the sentiments, of other users as a variable in such rules, personal safety program 115 identifies a series of opinions that indicate that restaurant A is over rated and should be rated at most two stars. As such, personal safety program 115 generates a message for the user indicating the actual four star rating along with an indication that the restaurant poses a potential hazard to the user according to popular opinion rating the restaurant as two stars.

In another example, a severe weather advisory for a thunderstorm is issued for an area. The user feels that an inclement weather advisory is sufficient to justify avoiding travel. As such, the user has defined a rule that results in the issuance of a message warning of inclement weather if such an advisory exists and the user attempts to plan to travel. However, personal safety program 115 identifies numerous opinions of users in close proximity to the user that indicate that the warning is an exaggeration since the thunderstorm is actually fifteen miles east of the user and the wind is blowing the thunderstorm further east. As such, personal safety program 115 generates a message for the user indicating the severe weather advisory along with an indication that the thunderstorm does not pose a hazard to the user according to popular opinion. As such, the user then decides whether or not the potential hazard is sufficient to warrant not traveling.

In a third example, a user enjoys visiting a park on Sundays. However, they do not like mosquito bites and have created a rule to limit their exposure to them. The weather has been very warm and there has been intermittent rain showers for two weeks. As such, personal safety program 115 identifies a number of opinions that indicate that there will be a large number of mosquitos in heavily vegetated areas. Based on this opinion, personal safety program 115 predicts that, since the park is an area with heavy vegetation, the park will have a large number of mosquitos. In other words, personal safety program 115 predicts a state of being for the park that is used as a variable in the rule. Based on the result of the rule, personal safety program 115 generates a message warning the user of the impending increase in mosquito population at the park. Other examples of a state of being for a subject are related to, for example, whether a venue is open or closed, routes of accessibility for a location (e.g., whether the location is accessible), the presence of or lack of an object or entity at a location, etc. In general, a state of being includes a characteristic that is associated with a person, location, or object.

It is to be noted that in certain embodiments, the opinions of other users can increase or decrease the threshold that is used by a rule to determine whether or not a potential hazard exists. In some cases, this results in a scenario where an assessment of the potential hazard becomes less sensitive to certain variables, i.e., the variable has a decreased impact on the result of the rule. In some cases, this results in a scenario where an assessment of the potential hazard becomes more sensitive to certain variables, i.e., the variable has a greater impact on the result of the rule.

In exemplary embodiments, user profiles 116 includes profile information for users that are registered with personal safety program 115. For each respective user, such a profile includes rules which indicate which situations, objects or individuals are considered to present a hazard to that user. In some cases, the rules define a hazard as a combination of specific situations, objects or individuals. In some embodiments, a rule can dictate a course of action, which is often specified by the user as a course of action to be taken in response to a rule being met. For example, a rule is configured by a user such that if a particular child wanders more than five hundred feet past the bounds of their neighborhood, then personal safety program 115 is to send an alert to the parents of that child. In this particular example, the location of the child is based on a location reported by a mobile device that is with the child. Such a mobile device is included in mobile devices 120. In some cases, a rule includes a user defined threshold. For example, a threshold for a delay time, a distance, or a severity of a given hazard.

In some cases, a course of action to be taken is the issuance of an alert message to the user. In other situations, the dictated course of action is the issuance of an alert message to a second party, e.g., a family member of the user, an authority figure, or an agency such as the police department, fire department or a hospital. The rules included in user profiles 116 can include spatial limitations. For example, if the situations, objects or individuals are within a proximity to the individual, then the rule dictates that personal safety program 115 issue an alert message to inform the user of the potential hazard. For example, a user does not enjoy the company of acquaintance A. As such, the user can create a rule that warns of the proximity of acquaintance A when acquaintance A is closer than one thousand feet to the user, i.e., the rule includes a threshold of one thousand feet that is associated with acquaintance A. In some embodiments, such rules are generated based on input from the user during the registration process. In some embodiments, the rules can be updated according to the wishes of the user. In some embodiments, various combinations of situations, objects and individuals can be included under a variety of categories, which can aid the user in specifying which hazards are to be monitored via the rules included in user profiles 116.

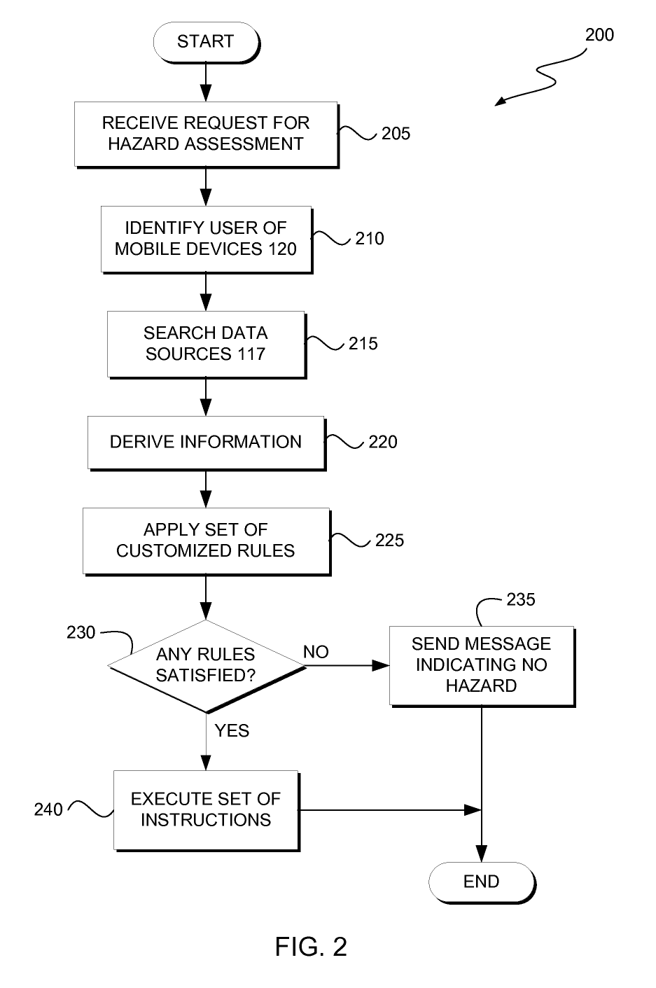

In exemplary embodiments, data sources 117 is a large body of data that is accessed by personal safety program 115 to determine whether any of the rules of user profiles 116 have been satisfied, which indicates that a potential hazard exists. Data sources 117 includes data from sources such as the internet. Data sources 117 can also include information such as the global positioning system (GPS) locations of various objects, events or individuals, e.g., weather events, buildings, transit stations, and people. In the embodiment described in the discussion of FIG. 2, data sources 117 further includes data from blogs and social media sites, which includes the opinions of people regarding a plethora of subjects.

In some embodiments, data sources 117 includes public databases. For example, judicially or administratively generated records and reports for an area or an individual, and property records that indicate a resident of a housing structure. In some embodiments, data sources 117 includes semi-public and private data sources. For example, data sources 117 may include data related to borders of properties, building ingress and egress, public and private buildings or structures, venues such as restaurants, nightclubs, and stadiums, jails and prisons, ankle bracelet data, and events with controlled or limited access (such as events that require tickets for admission). In some embodiments, data sources 117 includes public emergency alert services such as inclement weather warnings, amber alerts and air quality or allergen alerts. In some embodiments, data sources 117 includes GPS data originating from individuals (via carried/worn electronics like smartphones, tablets, laptops, watches, glasses, etc.), privately owned vehicles, and public transportation such as airplanes, trains, buses, subways, ferries and taxies. In some embodiments, data sources 117 includes static geo-location information for places of interest and concern, like stadiums, entertainment establishments, and the like. In some embodiments, data sources 117 includes data that can add context to another piece of data to increase or decrease the severity of a given hazard. For example, a potential hazard posed to an individual may be different depending on a mode of transit being utilized at that particular moment. In this case, a potential hazard for an individual that is walking can be different than a potential hazard for an individual in a moving automobile.

FIG. 2 is a flowchart, 200, illustrating operational processes of a personal safety program, executing on a computing device within the environment of FIG. 1, in accordance with an exemplary embodiment of the present disclosure.

In process 205, personal safety program 115 receives a request for a hazard assessment from a mobile device included in mobile devices 120. The exact circumstances under which personal safety program 115 receives a request for a hazard assessment can vary in certain embodiments. In some embodiments and scenarios, a user submits such a request for a hazard assessment. In some embodiments and scenarios, such a request for a hazard assessment is automatically generated and received by personal safety program 115 in response to user input that does not directly constitute a request. For example, a user enters in a planned destination into their mobile device. Personal safety program 115 identifies the destination as well as the route to be taken to reach that destination. Based on the route and destination, personal safety program 115 generates a request for a hazard assessment, which is subsequently received by personal safety program 115 and processed. In yet another scenario, personal safety program 115 identifies a user initiated search for local night clubs. In response, personal safety program 115 generates respective requests for hazard assessment for the top ten search results returned from the search, which are then received and processed by personal safety program 115. In such a scenario a user selection of a search result can trigger the generation of a request for a hazard assessment that utilizes an increased degree of granularity. In some embodiments, to increase the degree of granularity of a search, personal safety program 115 includes more specific information related to the selected search result, included in data sources 117, and expands the types of information retrieved from data sources 117.

In process 210, personal safety program 115 generates a set of search parameters to be applied to data included in data sources 117. To generate a set of search parameters to be applied to data included in data sources 117, personal safety program 115 accesses the user profile, included in user profiles 116, that is associated with the mobile device that issued the request for the hazard assessment. Based on the information included in the accessed user profile, personal safety program 115 identifies the user that is associated with that particular mobile device and accesses a set of customized rules for the associated user, which are included in the user profile of that user. In some embodiments, the request for the hazard assessment includes the identity of the user of the mobile device and an indication of which user created rules are to be applied. In some embodiments, the request includes the rules to be applied for the hazard assessment.

In process 215, personal safety program 115 searches data sources 117 for data to be used in the hazard assessment. Personal safety program 115 searches a variety of data sources, such as the data sources included in data sources 117, and collects real-time information by parsing the data retrieved from data sources 117. In certain embodiments, one or more aggregation techniques are applied to the collected data in order to yield a more statistically valid set of data, e.g., outlier pieces of data are removed from the collected data set. The parsing yields specific types of data that can be used as variables for the rules included in user profiles 116. For example, specific types of information include names, addresses, dates, routes etc. Personal safety program 115 also identifies an opinion of at least one user or the opinions of a plurality of users regarding the subjects that are assessed by the customized rules for the user that was identified in step 210. In some embodiments and scenarios the parsing also identifies the plurality of opinions of users. In some embodiments and scenarios the opinions of the plurality of users regarding the subjects are assessed to determine a consensus of those opinions, which is then used to represent the opinions of the plurality of users. In some scenarios, such a consensus includes the number of opinions that are positive and the number that are negative etc. For example, the opinions for a theatrical play are 60% positive, 33% negative and 7% neutral. As such, the overall consensus is that the play is held in a positive opinion, but one in three patrons did not enjoy the experience.

In process 220, personal safety program 115 derives information based on the data retrieved from data sources 117. The derived information may include an identification of an individual, a planned destination for an individual, and an opinion shared by a group of users for, for example, a particular location, the weather, an object, or a concert. A derived information is often not directly associated with a piece of information that is identified during an initial search. For example, an anonymous post in a chat room does not indicate the name of the user that added the post. However, the contents of the post includes information that indicates the following details about the user that made the post: that they will be at venue X, they live in neighborhood Y, that they enjoy foods A, B and C that are only served at that venue, and that their favorite color is orange. Using this information, personal safety program 115 compares the details about the user to the details about users that are included in a social media site. Based on a result of the comparison, personal safety program 115 identifies a probable identity for the user that made the anonymous post, i.e., the probable identity is the derived information.

In general, personal safety program 115 derives information by parsing the data retrieved from data sources 117 and retrieving new information from data sources 117 that is related to the parsed data. This new information includes specific data that can be used as variables for the rules included in user profiles 116. For example, there may be a statistical relationship between two words, synonym A and synonym B, which indicates that they are likely synonyms to one another. The original data retrieved from data sources 117 includes one of those synonyms, for example synonym A. As such, personal safety program 115 conducts a search using synonym B, which is the synonym that was not used in the original search. This second search yields a second collection/aggregate of real-time information that is based on data retrieved from data sources 117. In another example, personal safety program 115 identifies a sub-category of data that includes information regarding a variable identified in process 215. Personal safety program 115 then searches for and retrieves other information included in that sub-category, e.g., a movie playing at a movie theatre would fall under a category of movies currently playing in theatres, which could further yield an opinion for viewing that movie at that theater. As before, retrieved information is parsed to identify specific types of data that can be used as variables for the rules included in user profiles 116. In other embodiments, different methods of semantic analysis are applied by personal safety program 115 to search for and derive information based on the data retrieved from data sources 117. It is to be noted that the method used herein is not to be interpreted as a limitation as any number of such methods may be employed in a desired embodiment of the present invention.

In process 225, personal safety program 115 applies the set of customized rules, for the given user identified in step 210, to the aggregated real-time information and the derived information to generate a set of results. In other words, personal safety program 115 uses the aggregated real-time information and the derived information as variables that are plugged into their corresponding fields that are included in the rules. In some cases, a rule can include a field for a variable that corresponds to, for example, a number, a name, a location, or a threshold. The number of and type of variables utilized by a given rule often vary from one rule to the next. As such, each rule is assessed to determine if the variables yield a result that indicates that a hazard exists. In some cases, certain rules only require a single variable to exist to yield a result indicating that a hazard exists. In other cases, multiple variables are required to exist, sometimes with values in excess of a threshold, in order for a given rule to yield a result that indicates that a hazard exists.

Based on the set of results, in determination process 230, personal safety program 115 determines whether any of the rules, identified in step 210, have been satisfied such that a hazard is deemed to exist. In other words, personal safety program 115 determines whether a hazard exists based on the set of results indicating that a hazard exists. If personal safety program 115 determines that none of the rules associated with that particular user have been satisfied, then personal safety program 115 proceeds to process 235. In process 235, personal safety program 115 sends a message to the mobile device that issued the request for the hazard assessment indicating that no hazard was deemed to exist.

If personal safety program 115 determines that any of the rules associated with that particular user have been satisfied, then personal safety program 115 proceeds to process 240. In process 240, personal safety program 115 executes a set of actions in response to the type and number of hazards that are determined to exist. In some cases this is determined by further rules included in user profiles 116. In some instances, such actions include personal safety program 115 sending a message to the mobile device that issued the request for the hazard assessment to indicate that a hazard was identified, i.e., was deemed to exist. In such situations, certain details may be included in the message such as the planned destination, the type of hazard deemed to exist, the identity of certain individuals, warnings, or a course of action for the user to follow. In other cases, personal safety program 115 contacts another individual, such as a parent or authority figure, and informs them of the hazard. In such cases, the rules that are accessed in step 210 indicate who is to be contacted as well as a method of contact that is to be employed, e.g. an automated phone call, a text message, an email etc.

In certain embodiments, personal safety program 115 recommends an alternative course of action for the user, such that the potential hazard is (at least partially) avoided or the alternative action mitigates the chances of a potential hazard from being realized. For example, such a course of action can include an alternate route of transit to be used by the first user, an alternate venue to be attended by the first user, or an alternate event to be attended by the first user etc. In some embodiments, the alternate actions that are recommended are pre-programmed. In some embodiments, personal safety program 115 includes programming and functionality to: access user profiles 116 and data sources 117, identify a variable of a rule that can be changed via user action, and suggest a course of action that will result in the needed change such that the potential hazard is (at least partially) avoided or its chance of existing is mitigated. In some embodiments, such functionality is based on searches using a mapping program, a scheduling program or other like programs that are capable of determining alternative routes, venues and events for the user.

FIG. 3 depicts a block diagram, 300, of respective components of server computing device 110 and mobile devices 120, in accordance with an illustrative embodiment of the present disclosure. It should be appreciated that FIG. 3 provides only an illustration of one implementation and does not imply any limitations with regard to the environments in which different embodiments may be implemented. Many modifications to the depicted environment may be made.

Server computing device 110 and mobile devices 120 respectively include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Personal safety program 115, user profiles 116, and data sources 117 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of network 130. In these examples, communications unit 310 includes one or more network interface cards. Communications unit 310 may provide communications through the use of either or both physical and wireless communications links. Personal safety program 115, user profiles 116, and data sources 117 may be downloaded to persistent storage 308 through communications unit 310.

I/O interface(s) 312 allows for input and output of data with other devices that may be respectively connected to server computing device 110 and mobile devices 120. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., personal safety program 115, user profiles 116, and data sources 117, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method of recommending a course of action, the method comprising:
retrieving, by one or more processors, a set of data based, at least in part, on a variable of a rule, wherein the rule is configured to evaluate a subject based, at least in part, on a preference of a first user;
identifying, by one or more processors, an opinion of a second user regarding the subject;
defining, by one or more processors, a value that corresponds to the variable of the rule based, at least in part, on the opinion of the second user and at least a part of the set of data; and
determining, by one or more processors, a course of action that is recommended for the first user, the determination being based, at least in part, on incorporation of the value as the variable of the rule and on the preference of the first user.

2. The method of claim 1, the method further comprising:
parsing, by one or more processors, the set of data to identify a first information; and
deriving, by one or more processors, a second information that is associated with the subject based, at least in part, on the first information, wherein the second information allows for identification of the opinion of the second user.

3. The method of claim 2, wherein the derived second information includes at least one of an identification of the subject, a destination of the subject, or an opinion shared by a group of users for the subject, and wherein the subject is at least one of an object, an individual or an event.

4. The method of claim 2, the method further comprising:
determining, by one or more processors, a status of the subject based, at least in part, on one or both of the set of data and the second information, wherein the status includes one or both of a predicted location of the subject and a predicted state of being of the subject.

5. The method of claim 1, the method further comprising:
determining, by one or more processors, whether two or more pieces of information included in the set of data, when combined, yield the value that generates the result, wherein the two or more pieces of information do not separately yield the value that generates the result.

6. The method of claim 1, wherein the rule is configured to evaluate the subject such that the first user will receive a warning if the result of the rule indicates a potential undesired result for the first user.

7. The method of claim 1, wherein the step of determining, by one or more processors, a course of action to be recommended for the first user based, at least in part, on a result generated by applying the value to the rule and on the preference of the first user further comprises:
executing, by one or more processors, the rule using the value, wherein a result of the execution of the rule dictates, at least in part, a content of a message to be presented to the first user;
determining, by one or more processors, an alternative to be included as part of the course of action to be recommend for the first user, wherein the alternative includes at least one selected from the group consisting of an alternate route of transit to be used by the first user, an alternate venue to be attended by the first user, and an alternate event to be attended by the first user; and
presenting, by one or more processors, the message to the first user, wherein the message includes both the content that is dictated and the alternative.

8. A computer program product for recommending a course of action, the computer program product comprising:
a computer readable storage medium and program instructions stored on the computer readable storage medium, the program instructions comprising:
program instructions to retrieve a set of data based, at least in part, on a variable of a rule, wherein the rule is configured to evaluate a subject based, at least in part, on a preference of a first user;
program instructions to identify an opinion of a second user regarding the subject;
program instructions to define a value that corresponds to the variable of the rule based, at least in part, on the opinion of the second user and at least a part of the set of data; and
program instructions to determine a course of action that is recommended for the first user, the determination being based, at least in part, on incorporation of the value as the variable of the rule and on the preference of the first user.

9. The computer program product of claim 8, the program instructions further comprising:
program instructions to parse the set of data to identify a first information; and
program instructions to derive a second information that is associated with the subject based, at least in part, on the first information, wherein the second information allows for identification of the opinion of the second user.

10. The computer program product of claim 9, wherein the derived second information includes at least one of an identification of the subject, a destination of the subject, or an opinion shared by a group of users for the subject, and wherein the subject is at least one of an object, an individual or an event.

11. The computer program product of claim 9, the program instructions further comprising:
program instructions to determine a status of the subject based, at least in part, on one or both of the set of data and the second information, wherein the status includes one or both of a predicted location of the subject and a predicted state of being of the subject.

12. The computer program product of claim 8, the program instructions further comprising:
program instructions to determine whether two or more pieces of information included in the set of data, when combined, yield the value that generates the result, wherein the two or more pieces of information do not separately yield the value that generates the result.

13. The computer program product of claim 8, wherein the rule is configured to evaluate the subject such that the first user will receive a warning if the result of the rule indicates a potential undesired result for the first user.

14. The computer program product of claim 8, wherein the program instructions to determine a course of action that is recommended for the first user based, at least in part, on a result generated by applying the value to the rule and on the preference of the first user further comprises:
program instructions to executing, by one or more processors, the rule using the value, wherein a result of the execution of the rule dictates, at least in part, a content of a message to be presented to the first user;
program instructions to determine an alternative to be included as part of the course of action to be recommend for the first user, wherein the alternative includes at least one selected from the group consisting of an alternate route of transit to be used by the first user, an alternate venue to be attended by the first user, and an alternate event to be attended by the first user; and
program instructions to present the message to the first user, wherein the message includes both the content that is dictated and the alternative.

15. A computer system for recommending a course of action, the computer system comprising:
one or more computer processors;
one or more computer readable storage media;
program instructions stored on the computer readable storage media for execution by at least one of the one or more processors, the program instructions comprising:
program instructions to retrieve a set of data based, at least in part, on a variable of a rule, wherein the rule is configured to evaluate a subject based, at least in part, on a preference of a first user;
program instructions to identify an opinion of a second user regarding the subject;
program instructions to define a value that corresponds to the variable of the rule based, at least in part, on the opinion of the second user and at least a part of the set of data; and
program instructions to determine a course of action that is recommended for the first user, the determination being based, at least in part, on incorporation of the value as the variable of the rule and on the preference of the first user

16. The computer system of claim 15, the method further comprising:
program instructions to parse the set of data to identify a first information; and
program instructions to derive a second information that is associated with the subject based, at least in part, on the first information, wherein the second information allows for identification of the opinion of the second user.

17. The computer system of claim 16, wherein the derived second information includes at least one of an identification of the subject, a destination of the subject, or an opinion shared by a group of users for the subject, and wherein the subject is at least one of an object, an individual or an event.

18. The computer system of claim 16, the method further comprising:
program instructions to determine a status of the subject based, at least in part, on one or both of the set of data and the second information, wherein the status includes one or both of a predicted location of the subject and a predicted state of being of the subject.

19. The computer system of claim 15, wherein the rule is configured to evaluate the subject such that the first user will receive a warning if the result of the rule indicates a potential undesired result for the first user.

20. The computer system of claim 15, wherein the program instructions to determine a course of action that is recommended for the first user based, at least in part, on a result generated by applying the value to the rule and on the preference of the first user further comprises:
program instructions to executing, by one or more processors, the rule using the value, wherein a result of the execution of the rule dictates, at least in part, a content of a message to be presented to the first user;
program instructions to determine an alternative to be included as part of the course of action to be recommend for the first user, wherein the alternative includes at least one selected from the group consisting of an alternate route of transit to be used by the first user, an alternate venue to be attended by the first user, and an alternate event to be attended by the first user; and
program instructions to present the message to the first user, wherein the message includes both the content that is dictated and the alternative.
